(19) United States
(12) Patent Application Publication
(10) Pub. No.: US 2009/0178758 A1
(43) Pub. Date: Jul. 16, 2009

(54) METHOD OF ARRANGING STACKED CHIP BY PHOTO-CURING ADHESIVE

(75) Inventor: Chung-Mao Yeh, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: LINGSEN PRECISION INDUSTRIES, LTD., Taichung (TW)

(21) Appl. No.: 12/263,285

(22) Filed: Oct. 31, 2008

(30) Foreign Application Priority Data
Jan. 16, 2008 (TW) 97101707

(51) Int. Cl. B29C 65/02

(52) U.S. Cl. 156/273.3

(57) ABSTRACT

A method of arranging stacked chips by photo-curing adhesive includes the steps of disposing a first chip on a top side of a substrate and electrically connecting the first chip to the substrate by wire bonding; forming a photo-curing adhesive layer on a top side of the first chip; hardening the photo-curing adhesive layer by irradiation to convert it from colloid to solid for 70-80% degree of solidification; softening the photo-curing adhesive layer by heating of 50-80° C. to convert it from solid to semisolid to enable the photo-curing adhesive layer to be adherent; disposing a second chip on a top side of the photo-curing adhesive layer, then converting the photo-curing adhesive layer from semisolid to complete solid by heating of 100-150° C., and finally electrically connecting the second chip to the substrate by wire bonding.

### BACKGROUND OF THE INVENTION

1. Field of the Invention

The present invention relates generally to manufacturing processes of stacked chips, and more particularly, to a method of arranging stacked chips by photo-curing adhesive.

2. Description of the Related Art

U.S. Pat. No. 5,323,060 disclosed a multi-chip module having a stacked chip arrangement, in which each two adjacent stacked chips are spaced from each other by a stack, a receiving space is formed between each two adjacent chips, and thus a plurality of gold wires electrically connected with the chips can be disposed in the receiving space.

However, the aforesaid stacks must be prepared beforehand in accordance with required specification for use with the stacked chips. In other words, the specification of the stack is limited after it is prepared; if it is intended to arrange the stacked chips having different specifications, it will be necessary to prepare the stacks having different specifications. Therefore, the aforesaid arrangement is defective for its low applicability to need further improvement.

### SUMMARY OF THE INVENTION

The primary objective of the present invention is to provide a method of arranging stacked chips by photo-curing adhesive, which is adjustable subject to different specifications of the chips to having high applicability.

The foregoing objective of the present invention is attained by the method includes the steps of disposing a first chip on a top side of a substrate and electrically connecting the first chip to the substrate by wire bonding; forming a photo-curing adhesive layer on a top side of the first chip; hardening the photo-curing adhesive layer by irradiation to convert it from colloid to solid for 70-80% degree of solidification; softening the photo-curing adhesive layer by heating of 50-80° C. to convert it from solid to semisolid to enable the photo-curing adhesive layer to be adherent; disposing a second chip on a top side of the photo-curing adhesive layer, then converting the photo-curing adhesive layer from semisolid to complete solid by heating of 100-150° C., and finally electrically connecting the second chip to the substrate by wire bonding.

### BRIEF DESCRIPTION OF THE DRAWINGS

FIG. 1 is a flow chart of a preferred embodiment of the present invention.

FIG. 2 is a schematic sectional view of the preferred embodiment of the present invention, illustrating the first step.

FIG. 3 is a schematic sectional view of the preferred embodiment of the present invention, illustrating the second step.

FIG. 4 is a schematic sectional view of the preferred embodiment of the present invention, illustrating the third step.

FIG. 5 is a schematic sectional view of the preferred embodiment of the present invention, illustrating the fifth step.

### DETAILED DESCRIPTION OF PREFERRED EMBODIMENTS

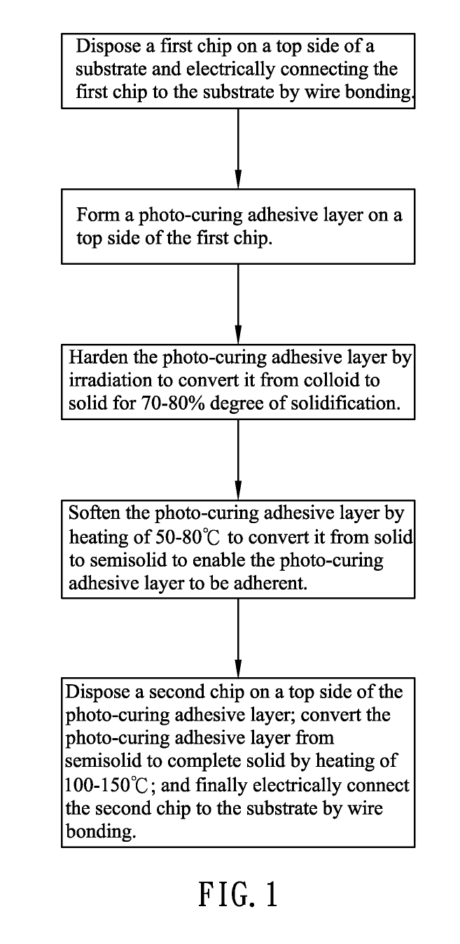

Referring to FIGS. 1-5, a method of arranging stacked chips by photo-curing adhesive in accordance with a preferred embodiment of the present invention includes the following steps.

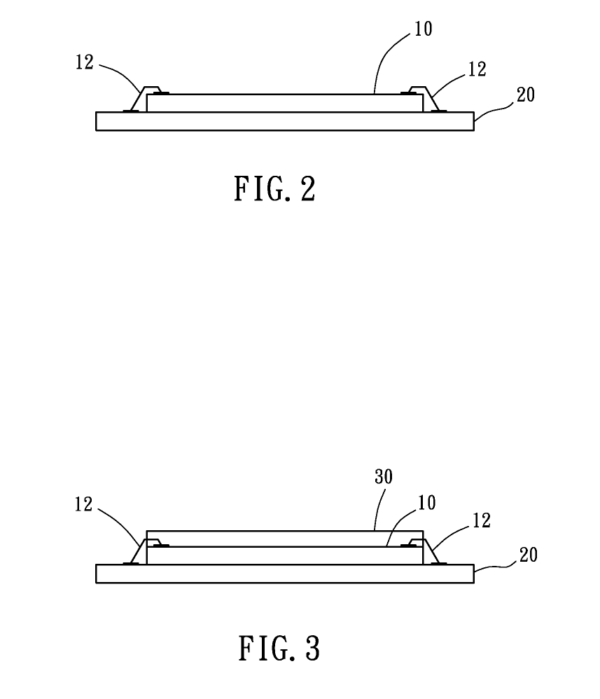

A. Dispose a first chip 10 onto a top side of a substrate 20 and electrically connect the first chip 10 with the substrate 20 by wire bonding of a plurality of gold wires 12, as shown in FIG. 2. The substrate 20 is selected from a group consisting of hard printed circuit, ceramic substrate, and lead frame. In this embodiment, the substrate 20 is a ceramic substrate.

B. Form a photo-curing adhesive layer 30 on a top side of the first chip 10, as shown in FIG. 3.

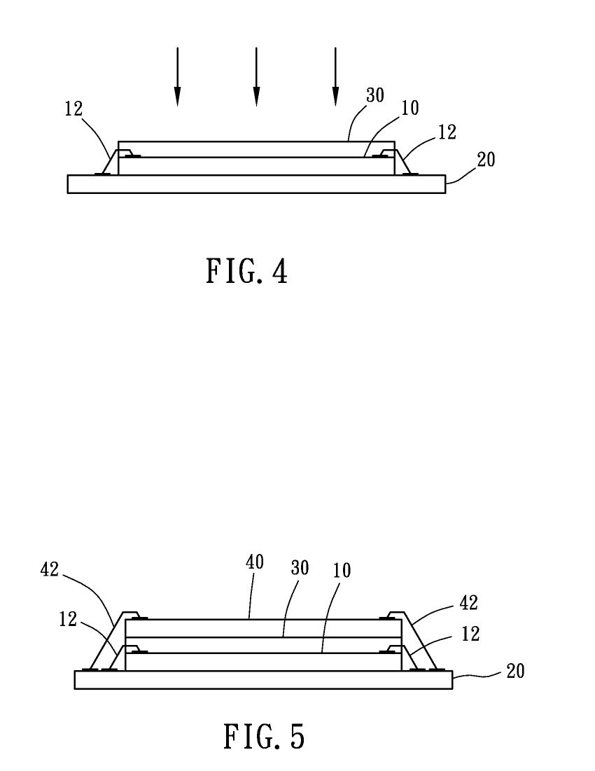

C. Harden the photo-curing adhesive layer 30 by irradiation to convert it from colloid to solid for 70-80% degree of solidification, as shown in FIG. 4. In this embodiment, the degree of solidification of the photo-curing adhesive 30 is preferably 75%.

D. Soften the photo-curing adhesive layer 30 by heating of 50-80° C. to convert it from solid to semisolid to enable the photo-curing adhesive layer to be adherent. In this embodiment, the temperature of the heating is preferably 75° C.

E. Dispose a second chip 40 on a top side of the photo-curing adhesive layer 30 and heat the photo-curing adhesive layer 30 to convert it from semisolid to complete solid by heating of 100-150° C., and finally electrically connect the second chip 40 with the substrate 20 by wire bonding of a plurality of gold wires 42, as shown in FIG. 5. In this embodiment, the heating is preferably of 120° C. Accordingly, the arrangement of the first chip 10 stacked on the second chip 40 is completed.

In light of the above steps, the present invention can adjust the thickness and the size of the photo-curing adhesive layer 30 subject to the sizes and the wiring requirements of the first and second chips 10 and 40 to further overcome the drawback of the prior art that it needs to prepare a stack beforehand and the stack fails to be adjustable subject to the specification, thus having high applicability.

In addition, if it is intended to stack a third chip (not shown), repeat the steps b-e for the second chip 40.

Although the present invention has been described with respect to a specific preferred embodiment thereof, it is no way limited to the details of the illustrated structures but changes and modifications may be made within the scope of the appended claims.

What is claimed is:

1. A method of arranging stacked chip by photo-curing adhesive, said method includes steps of:
(A) disposing a first chip on a top side of a substrate and electrically connecting the first chip to the substrate by wire bonding;
(B) forming a photo-curing adhesive layer on a top side of the first chip;
(C) hardening the photo-curing adhesive layer by irradiation to convert it from colloid to solid for 70-80% degree of solidification;
(D) softening the photo-curing adhesive layer by heating of 50-80° C. to convert it from solid to semisolid to enable the photo-curing adhesive layer to be adherent;
(E) disposing a second chip on a top side of the photo-curing adhesive layer, then converting the photo-curing adhesive layer from semisolid to complete solid by heating of 100-150° C., and finally electrically connecting the second chip to the substrate by wire bonding.

2. The method as defined in claim 1, wherein said substrate in the step (A) is selected from hard printed circuit board, ceramic substrate, and lead frame.

3. The method as defined in claim 1, wherein the heating in the step (D) is preferably 75° C. in temperature.

4. The method as defined in claim 1, wherein the heating in the step (E) is preferably 120° C. in temperature.
